(19) United States
(12) Patent Application Publication
(10) Pub. No.: US 2010/0206442 A1
(43) Pub. Date: Aug. 19, 2010

(54) Snow protective covers

(75) Inventor: Leonid Koltun, Newton, MA (US)

Correspondence Address: Leonid Koltun, 99 Needham St. Apt.1303, Newton, MA, 02461, US

(73) Assignees: Anna Beker, Newton, MA (US); Leonid Koltun, Newton, MA (US)

(21) Appl. No.: 12/378,320

(22) Filed: Feb. 17, 2009

(51) Int. Cl. B60J 11/04

(52) U.S. Cl. 150/166

(57) ABSTRACT

The snow protective covers is a clear vinyl or any kind of repeatedly used material with magnet strips which are adhesive to the covers. They can be placed on a car surface so the snow cover can be removed making the car clean. Also they can be used for protecting the car body or any metal surfaces from snow, damages and dirt.

### BACKGROUND OF INVENTION

In our application Ser. No. 12/006,839 from Jan. 7, 2008 the protective cover was used for protecting just car windows from snow. The present protective covers can protect all cars surface from snow including the windows and also to protect the car body from scratches, damages and dirt.

No other invention has been found similar to this.

### SUMMARY OF INVENTION

The present protective covers can be placed on external cars surface by using the magnet strips to protect the motor vehicles from snow by covering them while the car parked. The forms of the covers are different. It depend on what car parts are wanted to cover: all car surface or just windows. Using cover on all car surfaces, including windows, they can be placed at the individuals choosing. The size of the rectangle covers will be similar to the cars sizes. The forms of the covers for side windows and doors can also be rectangle but the top of the covers must be made for the car doors. It can be one piece to cover all side doors or the piece for each door. The offered covers are held on the car surface by magnet strips which are adhesive to the covers.

What this claim is:

1. Snow protective covers. The offered covers are using for parked motor vehicles. Covers are using to clean car surface and windows from snow. The arrangement manufactured from clear vinyl or any kind of material of the repeatedly using and adhesive magnet strips which must be stick to the cover and installed on vehicles metal surface, easy stick to the metal surface by magnet strips and so easily unstuck. The form of the covers for the top car surfaces are rectangle and sizes are similar to the car sizes. The form of the covers for the back car doors and windows also rectangle but the top part of the covers must copy of the car doors.

2. Snow protective covers can be used for any metal surfaces which need protection from snow, dirt and demages.
